(19) United States
(12) Patent Application Publication
(10) Pub. No.: US 2006/0110715 A1
(43) Pub. Date: May 25, 2006

(54) Verbal-visual framework method

(76) Inventor: Tommy Ray Hardy, Stamford, CT (US)

Correspondence Address: Tommy Ray Hardy, 81 Highland Road, Stamford, CT, 06902, US

(21) Appl. No.: 11/265,015

(22) Filed: Nov. 2, 2005

Related U.S. Application Data
(60) Provisional application No. 60/624,561, filed on Nov. 3, 2004.

(51) Int. Cl. G09B 19/00; G09B 5/00; G06Q 99/00

(52) U.S. Cl. 434/236; 434/307 R; 705/1

(57) ABSTRACT

A novel bipolar, multi-dimensional diagrammatic structure and related method for eliciting, organizing, analyzing, formulating, comparing, contrasting and communicating data pertaining to verbal-visual constructs within a research topic. Said invention serves as a quantitative means to structure literal, symbolic, familiar and preferred bipolar referential connections dealing with specific representational verbal and visual stimuli. Use of the invention provides insight, understanding and guidance to identify the most appropriate verbal-visual attitude construct necessary to guide the expression of a company's identity that will resonate with target consumers' perceptions and values. Said identity includes, but is not limited to, the design of elements such as products, packaging, logos, graphic elements, marketing communications, retail environments, Internet websites and advertising campaigns. The invention structures adjectives, images and sounds within a bipolar geometric semantic space in a novel manner that forms multiple layers of associations between form and meaning. Said semantic space is one of maximum efficiency as the bipolar adjective axes, bipolar character zones and bipolar individual adjectives are universally fundamental sets that apply to any concept and thereby exhaust the dimensionality of the space. This invention functions in a new and unique manner to define, formulate, guide, measure, illustrate and communicate multi-dimensional verbal-visual relationships and attitude constructs.

### BACKGROUND

1. Field of the Invention

This invention relates to an improved process for research, marketing, brand development, communications and design. Specifically, a novel multi-dimensional bipolar diagrammatic structure and related method functioning as a means to portray associations of meaning between verbal and visual stimuli in order to formulate an attitude construct. Said invention serves as a means to integrate multi-dimensional semantic factors such as consumer verbal-visual perceptions, basic design principles of form, line, color and texture, bipolar adjective sets and bipolar imagery sets, including desired verbal-visual characteristics of brands, products and services. It offers a means to help define, guide, formulate, structure, measure and communicate verbal-visual personality for a company's brand identity and its related elements. Such brand identity elements include, but are not limited to: products, services, packaging, logos, graphic elements, marketing communications, retail environments, Internet sites and advertising.

2. Description of Prior Art

Over the past fifty years or so, the economic base in developed countries has shifted from being primarily production-driven to include a greater degree of emphasis on being consumption-driven. This dynamic has evolved from mass production to embrace mass customization; and from consumer rationality and objectivity to more emphasis on consumer emotions and subjectivity. In this new marketplace atmosphere where technology is often a readily obtainable commodity, design and differentiated experiences are valuable currencies, especially when an idea creates a compelling brand, product or service that resonates directly with a target consumer's values, needs and desires.

For purposes of clarification, a brand is not simply a company's name, logo, product or package design. A brand reflects a specific personality, or attitude, about the overall company; both as intended by the company as its desired identity and as the perceived image of the consumer. Brand image, as seen by the consumer, is based on perceptions derived from various sources such as advertising, shopping, marketing communications and first-hand use of a company's products and services. Such perceptions are very often more emotional than rational.

Therefore, management must deal with satisfying emotional feelings and desires of their target consumers as well as their fundamental rational needs.

For example, because many companies can readily obtain identical technologies, the consumer reasons for choice are very often more symbolic. What a product looks like, what kind of image it conveys for the buyer who possesses it and whether the company that produced it is trustworthy, now affects consumer decision-making more than simply assessing its features and price. Creating brand trust with consumers is the cornerstone of brand-building and ultimately business success. Unfortunately, creating trust can be undermined by a gap of misunderstanding between company business strategy and underlying consumer perceptions.

This problem is driven primarily by most existing marketing and design research methods which deal with consumer opinions of visual stimuli by eliciting unidirectional group responses to questions such as “Which one do you like?” or “Do you like it or not?”. Likewise, companies very often are led in a particular direction because an influential executive or designer simply asserts. “It should be this way because I think it looks good”. Such qualitative approaches are in direct opposition to understanding underlying emotional perceptions of verbal-visual associations based on mental models of a consumer's literal, symbolic, familiar and preferred referential memory connections. In other words, more often than not, the research and development process fails to ensure that specific verbal stimuli representing a company and its products are associated with the most appropriate visual stimuli needed to create positive, referential connections within the target consumer's mental model.

Relative to prior art in context of subject invention, semantic differential scaling is a well-known research technique that was developed by psychologist Charles E. Osgood in 1952 to measure connotative meanings of concepts. The technique was further described by Osgood, Suci and Tannenbaum (1957) in The Measurement of Meaning. A central concept in the technique's construction is the notion of geometric semantic space which is bounded on a one-dimensional level by two bipolar adjectives that are used to represent opposite meanings of a particular construct (concept). A seven-segment, equal increment linear scale is employed with the adjectives being positioned at opposite ends. In practice, a test subject will look at a specific construct term, such as “Mother”, and then select one of seven marks on the scale towards either of the bounded bipolar adjectives, such as “loving” and “hateful”. The intensity or strength of feeling an individual has towards the construct increases or decreases, dependent on direction of movement along the scale towards one adjective or the other. Psychologists have continued to apply the semantic differential scaling technique for over fifty years to determine the underlying psychological meaning of words as well as specific personalities of people.

Other prior art techniques for gaining insights into consumer preferences and emotional associations are written surveys, personal interviews and focus groups. The latter being a group of subjects asked to address a specific research topic en masse while grouped together in the same room and guided through an interactive dialogue via an independent facilitator. Focus group dynamics, however, inevitably have participants with dominating characteristics who influence the opinions of others in the room. Similarly, use of survey techniques alone cannot capture emotional responses beneath preferences and the personal interview process most often results in subjects saying what they think the interviewer wants to hear.

However, there are pre-existing marketing and design research tools that can effectively address verbal-visual associations and consumer perceptions by using metaphor elicitation techniques. Metaphor is a representation of an entity in which a word, image or sound is transferred from the entity it usually designates to another entity it may designate only by implicit comparison or analogy. One such method is ZMET, The Zaltman Metaphor Elicitation Technique, and was developed by Professor Gerald Zaltman of Harvard Business School. ZMET uses images gathered and/or generated by consumers to elicit and probe the metaphors that represent thoughts and feelings about a topic. By having people select their own images based on their personal lives and situations, the ZMET method gives participants control of the research stimuli and sense of involvement. Their interpretations are then revealed during an interview process and analyzed by professional researchers. Results are aggregated via consensus maps to understand patterns of relationships.

With regards to pre-existing research and analysis mapping techniques, the following are the most relevant to this invention: Scatterplot Mapping is a method used to provide a visual picture of the relationship between two variables and as such aids in identifying potential associations; Correspondence Mapping, also called Perception Mapping, is an approach to represent tabular categorical data in the same two-dimensional space for visual analysis of tables composed of rows and columns. Correspondence Mapping can suggest dimensions and relationships by determining a measure of distance.

Other verbal-visual research techniques employ metaphor elicitation in combination with semantic differential scaling to identify perceptions and suggest personality profiles. One such process entitled Visual Positioning was developed by Barry Shepard and Will Rodgers of SHR Perceptual Management. The intent is to discover-dimensions and visual cues that appropriately represent a desired brand identity. The methodology includes consumer visual research using focus groups where consumers place photographic metaphors of various subjects along a uni-dimensional semantic differential scale on a table between two words representing a desirable brand dimension and it's less desirable opposite. This process involves consumer focus group-based dialogue dynamics and decision-making. Focus group results are organized by researchers in semantic differential scale formats termed Spectrums, which structure visual cues in the form of a visual positioning strategy reflecting the specific set of core brand dimensions.

However, while the prior art techniques discovered are effective individually, they do not equate to the novel bipolar structure and method of the Verbal-Visual Framework Method invention described herein. A key to the novelty of said invention resides in the ability of its bipolar, multi-dimensional diagrammatic structure to quantitatively determine verbal-visual interrelationships to yield a representative construct and collective educated hypothesis in a holistic manner.

### BRIEF SUMMARY OF THE INVENTION

The present Verbal-Visual Framework Method invention is a novel, multi-dimensional, bipolar scaled structure and attitudinal mapping method that incorporates the basic techniques of semantic differential scaling utilizing bipolar adjectives and bipolar imagery in conjunction with metaphor associations, verbal-visual perceptions and interrelationships with fundamental design principles. This novel method is comprised of comprehensive bipolar verbal-visual factors structured in multiple layers, each having similar, complementary and opposing associations, with each diemension bounded by common sets of bipolar axis adjective scales, character zones scales and related bipolar adjective scales all within a geometric semantic space. Said scales represent a common set of semantic determinants that are universally stable across any type of concept and are understood by any culture, race, gender or age. Said invention enables appropriate alignment against critical variables to identify relevant constructs, while providing a marketing, branding and design tool that is definable, repeatable and measurable.

Verbal characteristics representing a company's current and desired personality model, as well as competitive personalities, are mapped within the multi-dimensional, bipolar diagrammatic structure and compared against elicited consumer verbal-visual mental models, including related metaphors. Consumer mental models are elicited primarily through one-on-one perception testing employing the semantic differential scale method with bipolar adjectives and visual imagery. Such one-on-one perception testing method yields individualized, quantitative results and is more effective than the more qualitative focus group approach.

Established verbal-visual associations, fundamental design principles and resulting character zones are key dimensions within the mapping method. Said multidimensional, bipolar diagrammatic structure serves to facilitate bipolar referential connections—literal, symbolic, familiar and preferred—dealing with specific representational verbal and visual stimuli. Special analytic techniques are used to position, rank order and formulate verbal-visual structure within the bipolar scaling process to provide a quantitative construct, as well as qualitative insights, of the most appropriate personality expression embodying both company strategy and target consumer values. The end result of said invention is the formulation of an attitude construct, or personality, with comparisons, contrasts, similarities, combinations and insights to effectively guide the definition, creation and measurement of design language needed to create brand identity elements such as products, services, packaging, logos, graphic elements, marketing communications, retail environments, Internet web sites and advertising campaigns.

The Verbal-Visual Framework Method invention serves as a means to ensure that intended verbal meaning is expressed in the most appropriate visual manner to effectively resonate with the target audience while presenting a compelling and coherent brand identity for the company.

### BRIEF DESCRIPTION OF FIGURES

FIG. 1—Verbal-Visual Framework Method context and related process steps illustration

FIG. 2—Verbal-Visual Framework Method structure—bipolar adjective axis scales

FIG. 3—Verbal-Visual Framework Method structure—bipolar adjective character zones

FIG. 4—Verbal-Visual Framework Method structure—bipolar image character zones

FIG. 5—Verbal-Visual Framework Method structure—bipolar sound character zones

FIG. 6—Verbal-Visual Framework Method structure—bipolar tonal zones: TA+, TA−, TC+, TC−

FIG. 7—Verbal-Visual Framework Method structure—bipolar tonal zones: TB+, TB−, TD+, TD−

FIG. 8—Verbal-Visual Framework Method structure—bipolar tonal zones: TA+2, TA−2,

FIG. 9—Verbal-Visual Framework Method structure—bipolar tonal zones: TC+2, TC−2,

FIG. 10—Verbal-Visual Framework Method structure—bipolar tonal zones: TB+2, TB−2

FIG. 11—Verbal-Visual Framework Method structure—bipolar tonal zones: TD+2, TD−2

FIG. 12—Verbal-Visual Framework Method structure—attitude constructs A1 & A2: TB+, TB−, TD+, TD−

FIG. 13—Verbal-Visual Framework Method structure—attitude constructs A1 & A2: TA+, TA−, TC+, TC−,

FIG. 14—Verbal-Visual Framework Method structure—attitude constructs A1 & A2: TA+2, TA−2

FIG. 15—Verbal-Visual Framework Method structure—attitude constructs A1 & A2: TC+2, TC−2

FIG. 16—Verbal-Visual Framework Method structure—attitude constructs A1 & A2: TB+2, TB−2

FIG. 17—Verbal-Visual Framework Method structure—attitude constructs A1 & A2: TDE+2, TD−2

### DETAILED DESCRIPTION OF THE PREFERRED PROCESS OF CARRYING OUT THE INVENTION

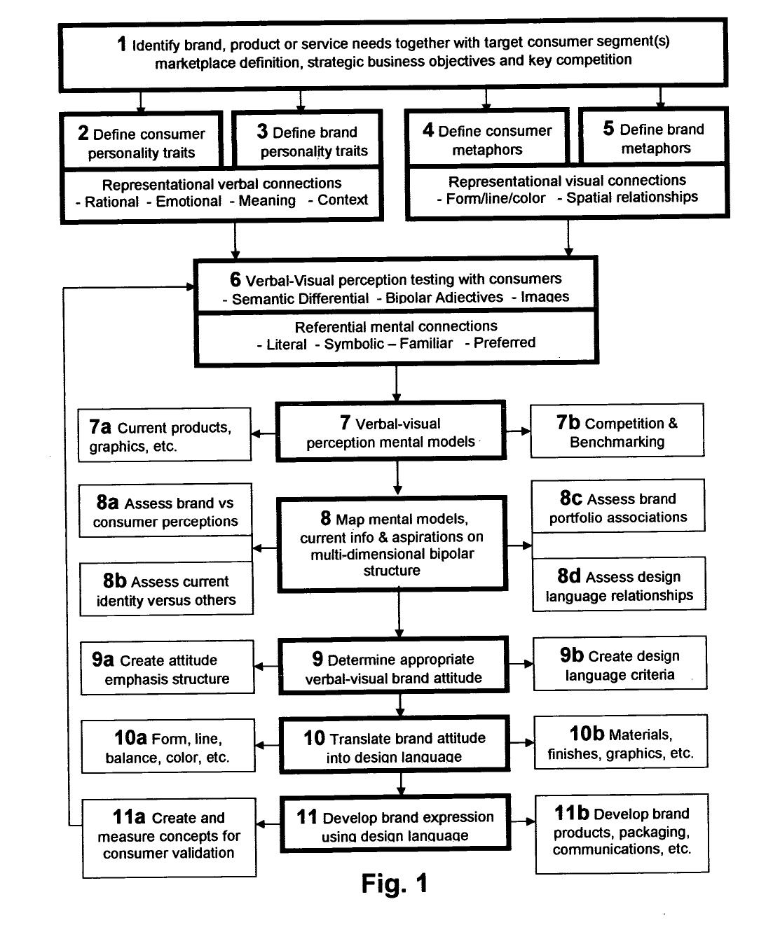

Referring to FIG. 1, preferred process steps relating to the Verbal-Visual Framework Method invention are described. Although process steps of the invention described in FIG. 1 are for purposes of illustration and context, it is understood that such detail is solely for that purpose, and variations can be made therein by those skilled in the art without departing from the spirit and scope of the invention. The preferred process consists of multiple steps that begin by first identifying in Step 1 (FIG. 1) a company's brand, product or service needs together with business information including, but not limited to, strategic goals, consumer segments, marketing objectives and key competition.

In Steps 2 and 3 (FIG. 1), representational verbal adjectives are identified as traits that signify meaning and context of brand and consumer personalities, both existing and ideal. Said adjectives are then categorized as being either rational or emotional. In complementary Steps 4 and 5 (FIG. 1), specific visual metaphor categories are selected that will resonate with both brand and consumer personality adjectives in terms such as: form, line, color, texture and spatial relationships.

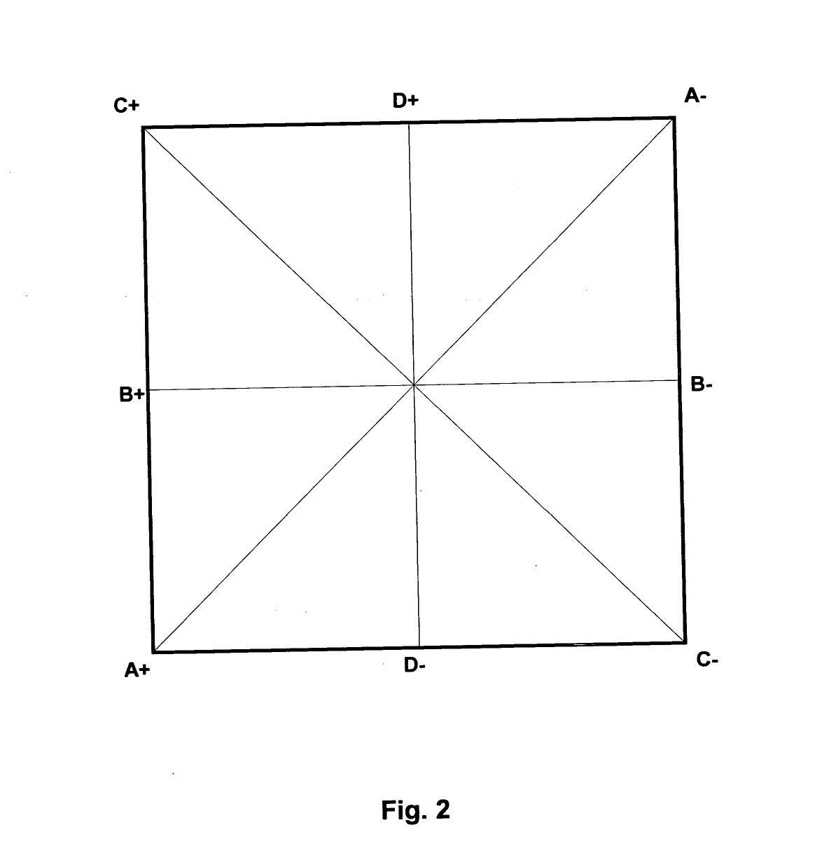

The next Step 6 (FIG. 1) involves conducting one-on-one verbal-visual perception testing with consumers. Such testing may also be conducted with company staff and others as necessary to compare and contrast quantitative results. The key objective is to determine basic referential mental connections—literal, symbolic, familiar, preferred—between the verbal personality adjectives identified in Steps 2 and 3 (FIG. 1), and the visual metaphors identified in Steps 4 and 5 (FIG. 1). This testing process utilizes a semantic differential scale of verbal bipolar adjective sets in association with specific visual images. The associated image can be represented by a visual metaphor identified in Steps 4 and 5 (FIG. 1), while the bipolar adjective set consists of a verbal personality adjective identified in Steps 2 and 3 (FIG. 1), together with its opposite. Adjective sets tested may also include the bipolar axis adjective sets that bound the multi-dimensional structure, as indicated in FIG. 2.

Upon assessing the test results from Step 6 (FIG. 1), mental models derived from each consumer-type, and/or other test subject-type, are formulated in Step 7 (FIG. 1) to represent verbal-visual perceptual associations between each adjective-image set. Said associations connect a specific image directly with a specific adjective or its opposite, or the association will indicate a blend between both adjectives on the scale. Additionally, consumer mental models can be compared against brand identity elements, such as existing product design in Step 7a (FIG. 1), as well as competition and best of breed in Step 7b (FIG. 1), to analyze specific preferences and patterns.

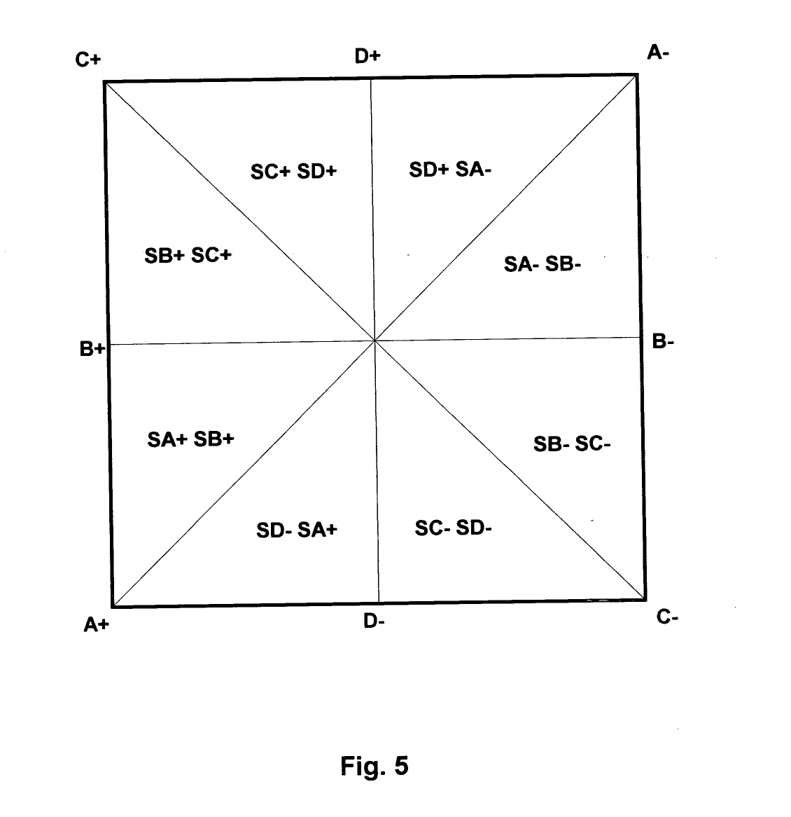

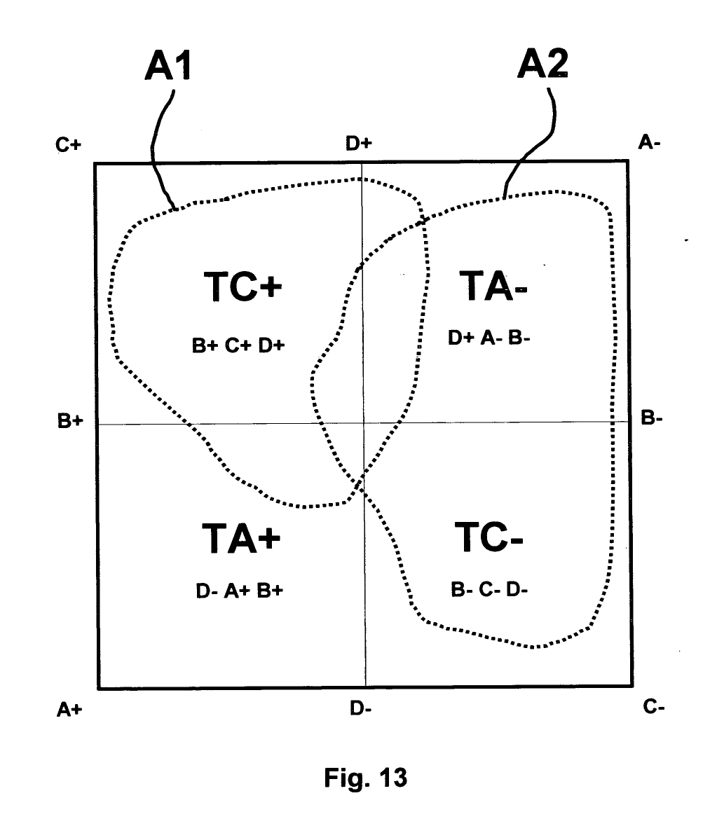

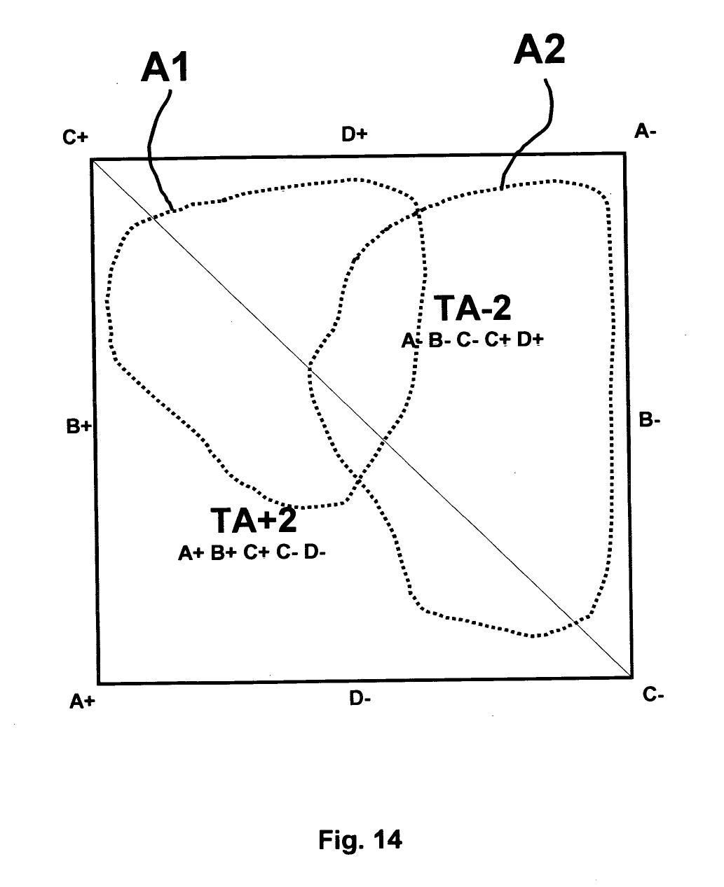

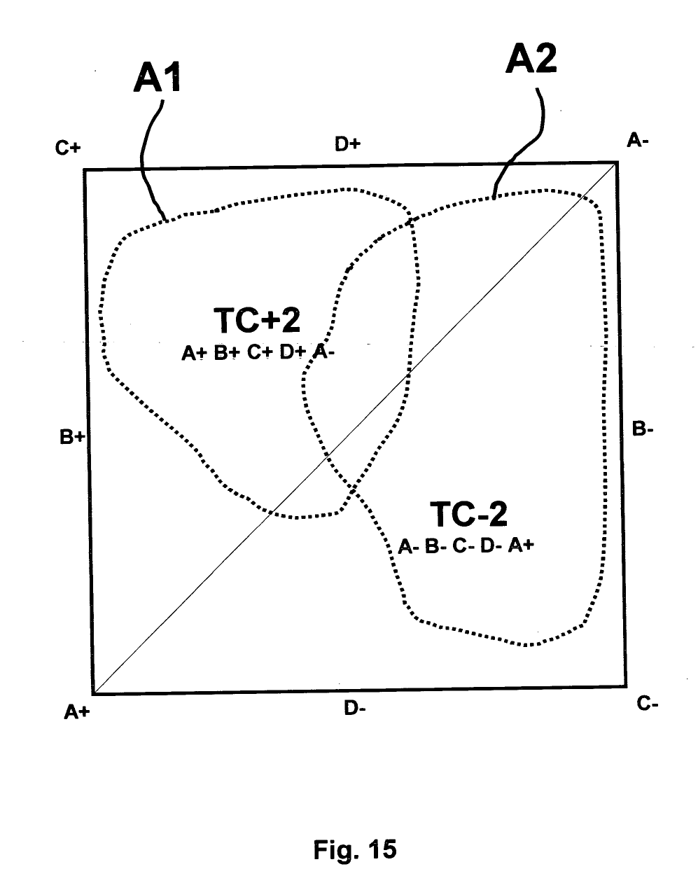

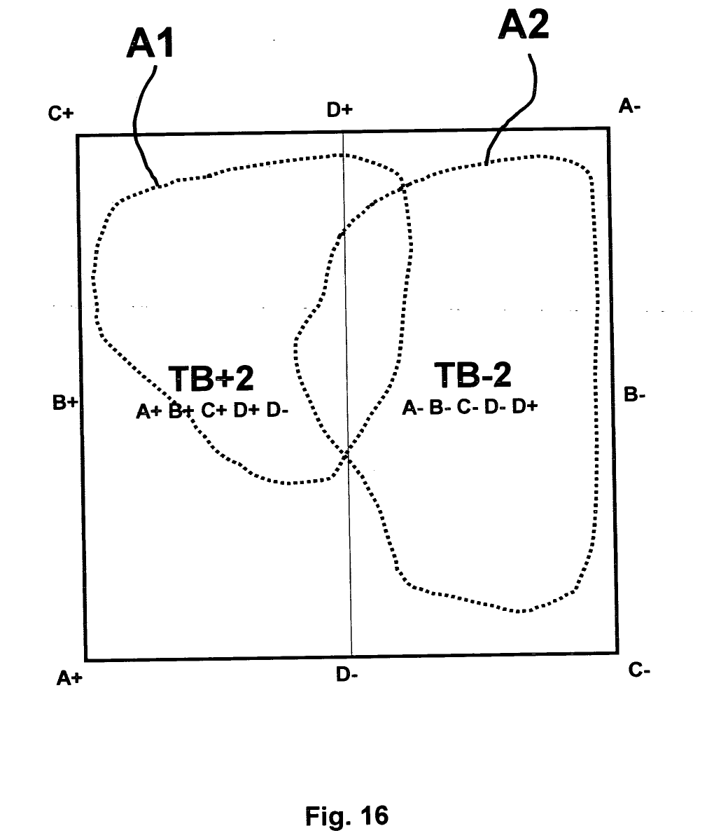

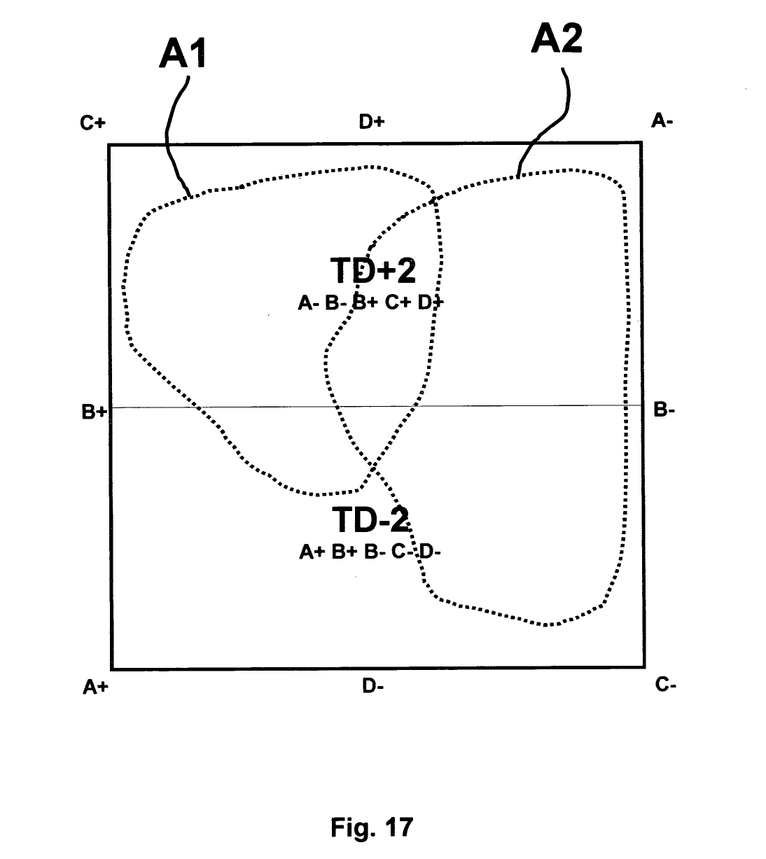

In Step 8 (FIG. 1), the novel multi-dimensional bipolar structure, illustrated in FIGS. 2-17, is utilized to position mental models and all relevant verbal-visual information from Steps 1-7 (FIG. 1). within the geometric semantic space. The multi-dimensional bipolar structure (FIGS. 2-17) embodies diversity and depth of verbal-visual content composition that serves as means for a wide range of assessments comparisons, contrasts and formulations to be conducted. For example, the ability to overlay direct associations between specific verbal meanings and specific forms, lines, colors, textures and spatial relationships as well as their contextual associations within a specific verbal-visual attitude construct. Additionally, sounds can be linked to specific verbal-visual associations for a complementary and emotional sensory dimension (FIG. 5).

The resulting verbal-visual relationships mapped using the novel multi-dimensional bipolar structure are then assessed in Step 8 (FIG. 1). against key criteria such as: (8a) brand versus consumer perceptions; (8b) consumer and brand values; (8c) brand portfolio associations; and (8d) design language relationships.

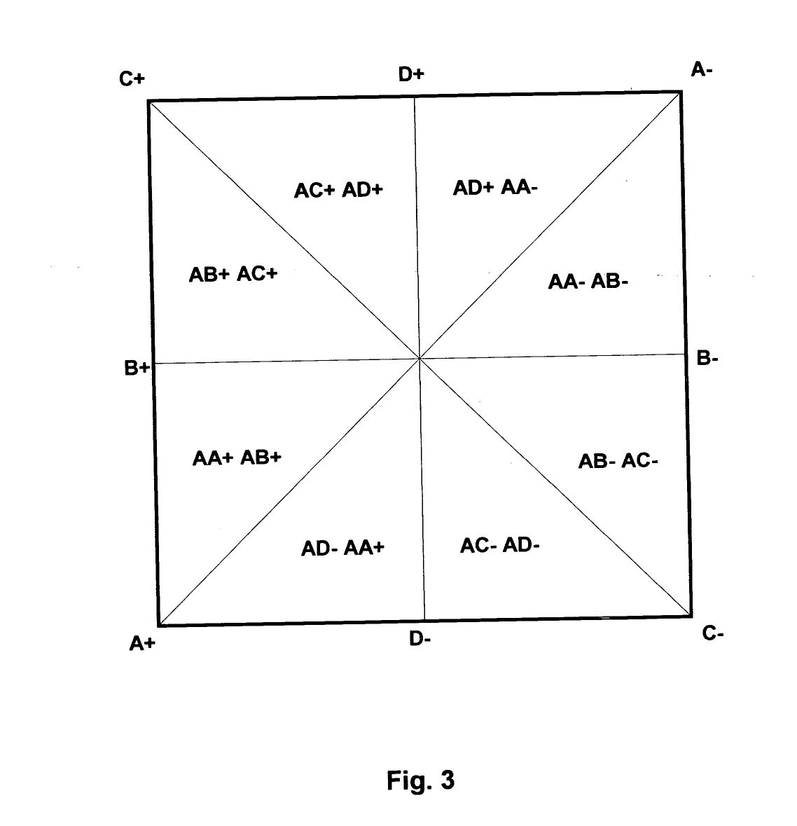

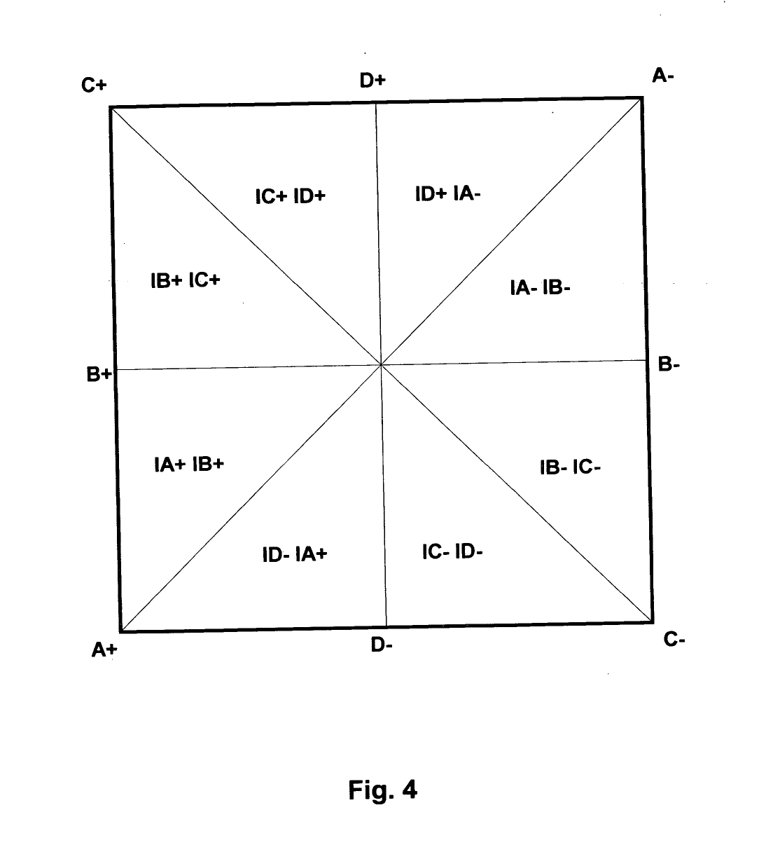

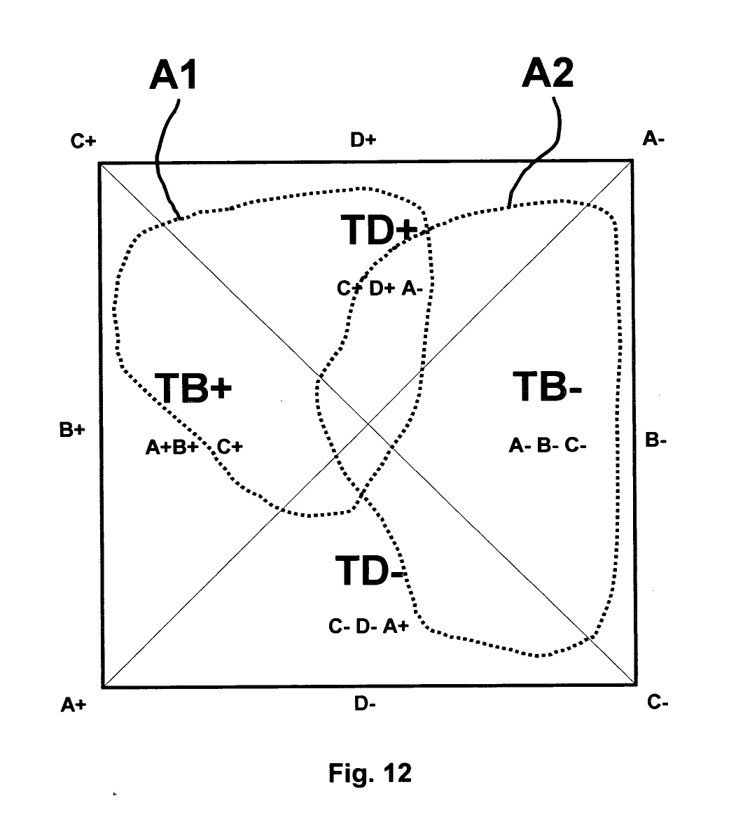

From Step 8, (FIG.1) the resulting verbal-visual framework maps and related character tones are then translated into overall brand character attitude constructs in Step 9, (FIG. 1) as illustrated in FIGS. 12-17. Two different attitudes constructs (A1, A2) are shown mapped in FIGS. 12-17 to illustrate verbal-visual concepts for two different brands. Each attitude construct map embodies specific adjectives (FIG. 3) and images (FIG. 4) that lie within the specific mapped character zone area. Each attitude construct map also occupies respective positions along bounded bipolar axis scales in each of FIGS. 12-17. The specific location of the attitude construct map within the geometric semantic space determines the degree of intensity or strength emphasized by a specific character zone, based on direction and distance towards one bipolar axis or the other.

By assessing attitude construct map positioning against bipolar axis adjectives bounding the geometric semantic space, together with identifying associated adjectives and visual imagery within the specific attitude construct character zone areas, a relative degree of character zone emphasis is designated. Said emphasis designation becomes a fundamental tone for the attitude construct. For example, in (FIG. 12) attitude construct A1 would be composed of 40% tone TB+, 45% of tone TD+, 10% of tone TD− and 5% of tone TB−. The resulting strategic attitude construct from Step 9a (FIG. 1) with degrees of verbal-visual tonal emphasis, together with specific character zone adjective meanings and image characteristics (FIG. 3-4), form the overall guiding principles for creating specific design language criteria in Step 9b (FIG. 1). The design language criteria for form, line, color, materials, textures and graphics, etc., developed in Step 9b (FIG. 1) is then transformed by Step 10 (FIG. 1) into specific design language visual cues in Steps 10a-10b

(FIG. 1). These interrelated visual cue elements, together with their attitude construct degree of tonal emphasis, are then applied in Step 11 (FIG. 1) for comprehensive development of brand identity areas such as product design, packaging, logos, graphic elements, marketing communications, Internet web sites and advertising campaigns.

During initial concept development in Step 11a (FIG. 1), consumer testing is conducted to validate that design direction fulfills the respective verbal-visual attitude construct as defined in Step 9 (FIG. 1), with its tonal emphasis and design language criteria. This step should be repeated as necessary throughout the finalized development in Step 11b (FIG. 1).

### DETAILED DESCRIPTION OF FIGURES

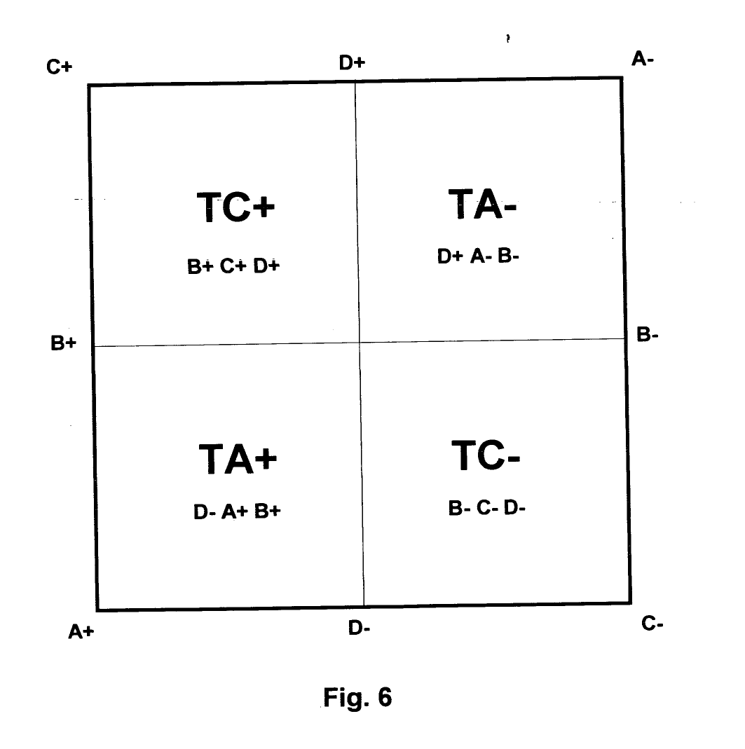

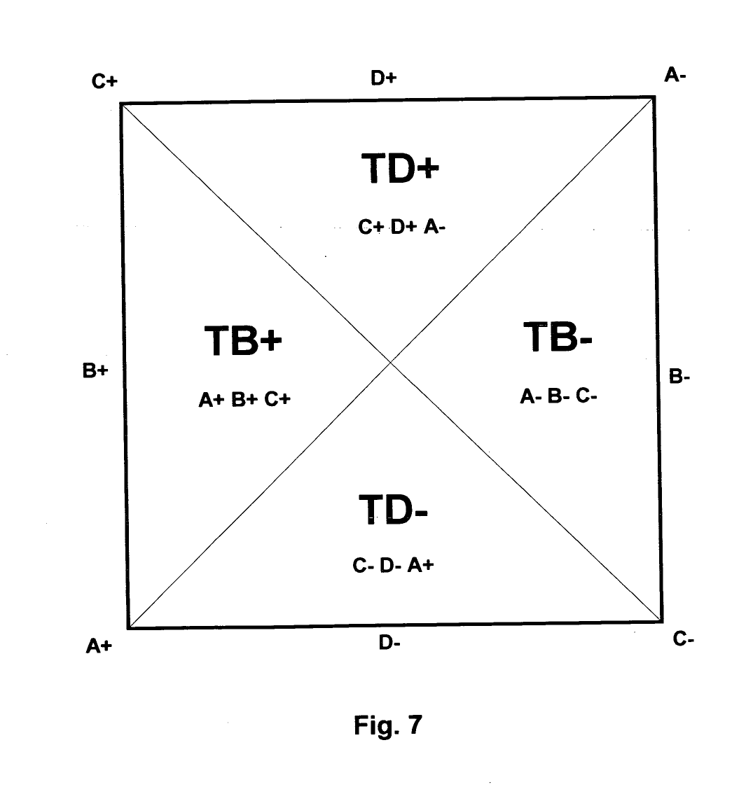

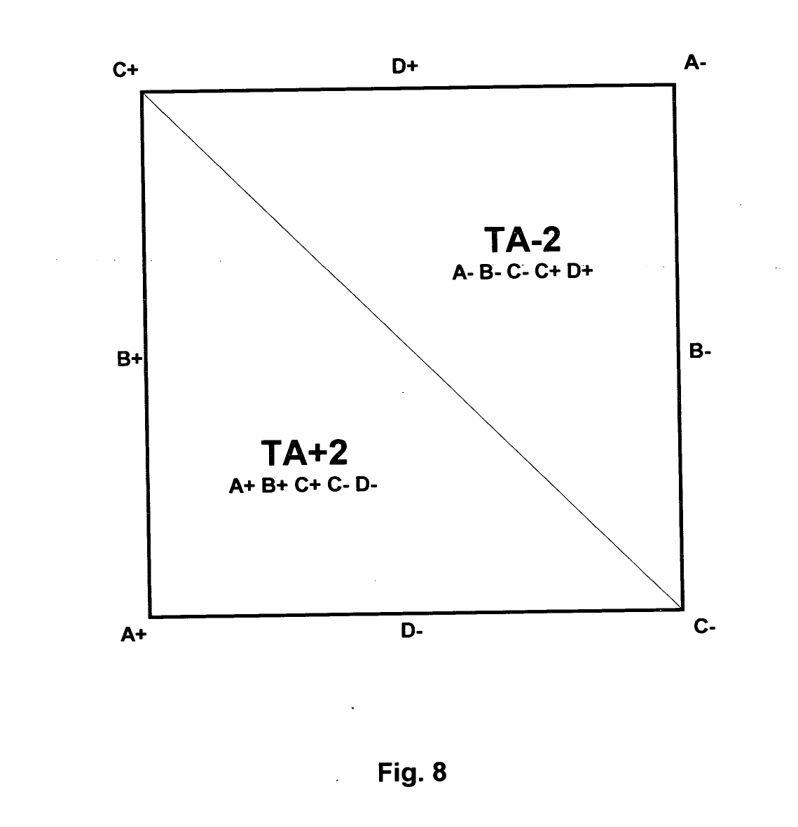

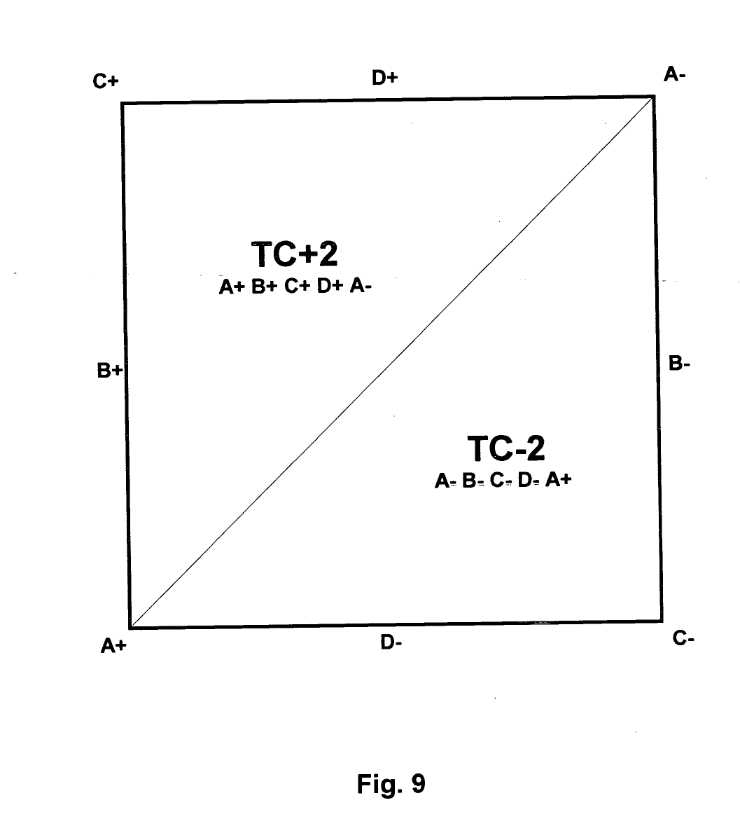

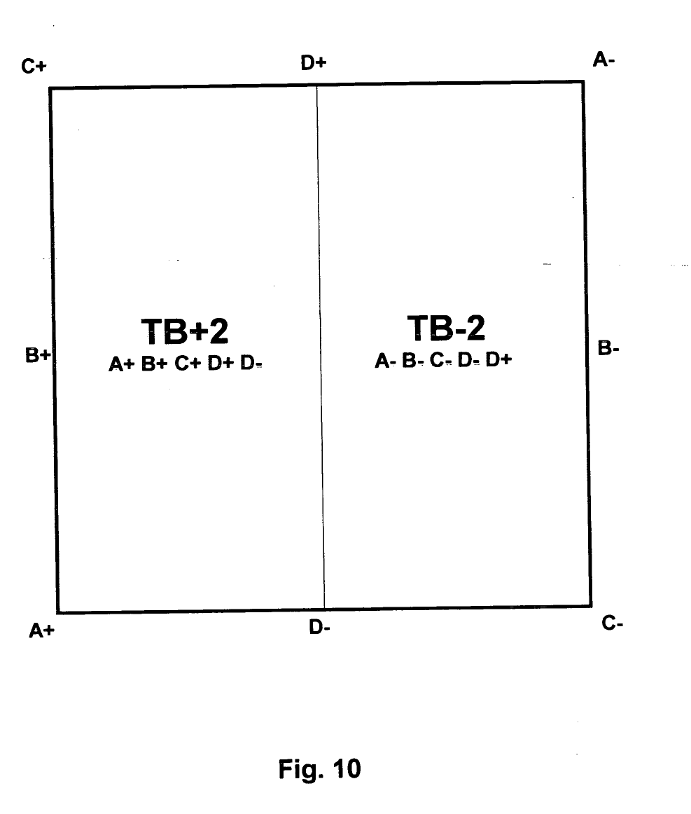

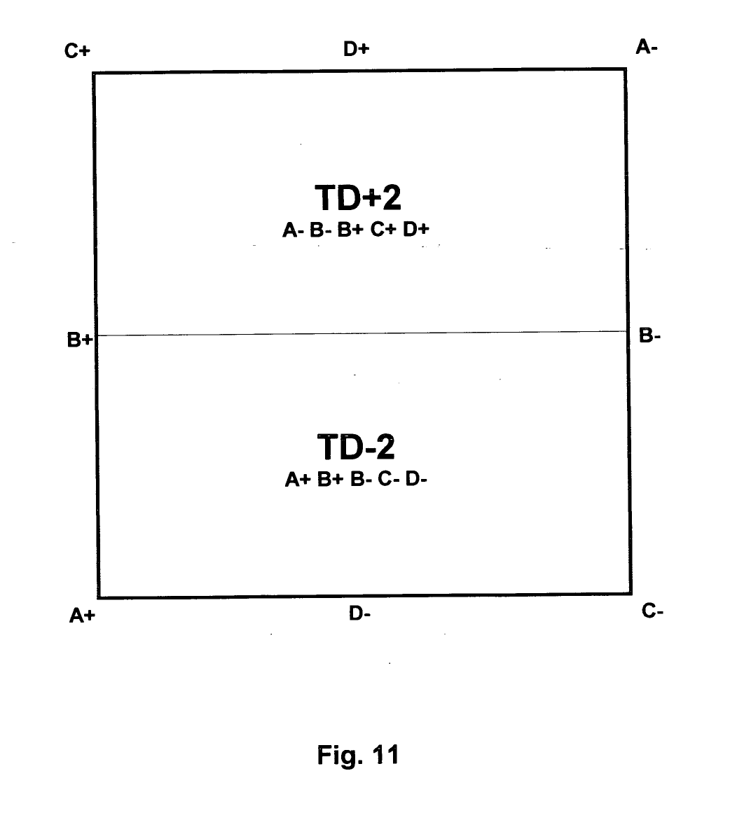

Although the framework content details described in FIG. 2-17 are for purpose of illustration, it is understood that such detail is solely for that purpose, and variations can be made therein by those skilled in the art without departing from the spirit and scope of the invention. The overall, bipolar multi-dimensional structure is comprised of, but not limited to, the following components and related methods:
(a) Eight bipolar adjectives that serve as four stable bounded axis sets (FIG. 2: A+,A−; B+,B; C+,C−; D+,D−) at equal distance from the center of the established geometric semantic space, Euclidian in character, and forming straight line scales passing through the center of said geometric semantic space; to define specific and unique character zones of the framework, with each adjective of the eight opposing axis points representing fundamental factors used to define fundamental bipolar verbal-visual associations and attitudes. Each bipolar axis adjective has a universally accepted and complementary relationship with its adjacent bounded axis adjective.
(b) Multiple bipolar adjectives (FIG. 3: A) that reside within character zones AA+AB+; AB+AC+; AC+AD+; AD+AA−; AA−AB−; AB−AC−; AC−AD−; AD−AA+ in FIG. 3 are individual adjectives used to characterize past, present or desired personality, of a person, product, idea, company brand, designed environment, symbol or any other entity. While said adjectives in any position can be individually variable, their meaning is always stable and synonymous relative to its position in the geometric semantic space. Each individual adjective (A) is positioned according to a stable grid structure enabling a definable, repeatable and measurable process.
(c) The number of character zones shown (FIG. 3: AA+AB+; AB+AC+; AC+AD+; AD+AA−; AA−AB−; AB−AC−; AC−AD−; AD−AA+), and their respective adjectives shown (FIG. 3: A) are for simplified illustration purposes only and do not indicate a minimum or limit on the number of individual zones, or the number of individual adjectives (A) that can reside within a character zone. Each character zone is positioned according to a stable grid structure enabling a definable, repeatable and measurable process.
(d) The selection and specific placement of individual adjectives (FIG. 3: A) within each character zone is based on proximity to relevant bounded bipolar axis adjectives (FIG. 2: A+,A−; B+,B; C+,C−; D+,D−) and related scale position characteristics. The adjective mapping position within the geometric semantic space serves as the operational definition of meaning at that point and embodies two properties that affect its specific meaning and location: (1) direction and (2) distance, based on the direction and distance towards one bounded bipolar axis adjective or another. Each adjective is located in the mirrored position of its opposing adjective along each scale in the geometric semantic space.
(e) Multiple bipolar adjectives (FIG. 3: A) that reside within the character zones (FIG. 3: AA+AB+; AB+AC+; AC+AD+; AD+AA−; AA−AB−; AB−AC−, AC−AD−; AD−AA+) created by the bounded bipolar axis adjective points (FIG. 2: A+A−; B+B; C+C−; D+D−) , with the meaning of each adjective (FIG. 3: A) relating directly to the character zone in which it resides. One opposing adjective of a bipolar pair always resides in a different character zone, such as one adjective (A) residing in FIG. 3: zone AC−AD− and its opposite (A) residing in FIG. 3: zone AB+AC+
(f) Multiple bipolar adjectives (FIG. 3: A) that reside within the same character zone, as in FIG. 3: Zone AC−AD−, are similarly related in tone, with specific meanings dependent on direction and distance towards one bounded bipolar axis adjective or another (FIG. 2: A+A−; B+B; C+C−; D+D−).
(g) Multiple bipolar images (FIG. 4: I) that reside within character zones (FIG. 4: IA+IB+; IB+IC+; IC+ID+; ID+IA−; IA−IB−; IB−IC−; IC−ID−; ID−IA+) created by the axis adjective points (FIG. 2: A+,A−; B+,B; C+,C−; D+,D−),;embody a character for each image relating to the zone in which it resides. One opposing image of a bipolar pair always resides in a different character zone, such as one image (I) residing in FIG. 4: zone IC−ID− and its opposite (I) residing in FIG. 4: zone IB+IC+
(h) The number of image character zones (FIG. 4: IA+IB+; IB+IC+; IC+ID+; ID+IA−; IA−IB−; IB−IC−: IC−ID−; ID−IA+) and their respective images (FIG. 4: I) are for are for simplified illustration purposes only and do not indicate a minimum or limit on the number of individual images that can be used within a character zone. Furthermore, the selection and specific placement of individual images within each character zone is based on proximity to relevant bounded bipolar axis adjectives (FIG. 2: A+A−; B+B; C+C−; D+D−) and related scale position characteristics. The image mapping point within the geometric semantic space serves as an operational definition of meaning at that point and embodies two properties that affect its meaning and location: (1) direction and (2) distance, based on the direction and distance towards one bounded bipolar axis adjective or another.
(i) Multiple bipolar images (FIG. 4: I) that reside within character zones (FIG. 4: IA+IB+; IB+IC+; IC+ID+; ID+IA−; IA−IB−; IB−IC−, IC−ID−; ID−IA+) of the framework embody the range of basic visual design elements that include, but are not limited to: shape, line, plane, solid, void, space, balance, tension, proportion, rhythm, texture, finish, material, value, composition and color.
(j) Multiple bipolar images (FIG. 4: I) that reside within the same character zone, as in FIG. 4: zone IC−,ID−, are similarly related in tone, with specific characteristics dependent on direction and distance towards one bounded bipolar axis adjective or another (FIG. 2:.A+A−; B+,B; C+,C−; D+,D−). Said images also embody similar meanings to adjectives (FIG. 3: A) that reside within the same character zone position, such as adjectives within FIG. 3: AD+AA− and images within FIG. 4: ID+IA−.
(k) The use of sound may be desired to complement and emphasize specific verbal-visual relationships as an additional sensory dimension. Therefore, if desired for added dimensionality, the multi-dimensional structure can include bipolar sound sets (FIG. 5: S) that reside within character zones (FIG. 5: SA+SB+; SB+SC+; SC+SD+; SD+,SA−; SA−SB−; SB−SC−, SC−SD−; SD−SA+).
(l) The number of individual sounds shown (FIG. 3: S) are for simplified illustration purposes only and do not indicate a minimum or limit on the number of individual sounds that can be used within a character zone. Furthermore, the selection and specific placement of individual sounds within each character zone is based on proximity to relevant bounded bipolar axis adjectives (FIG. 2: A+,A−; B+,B; C+,C−; D+,D−) and related scale position characteristics. The sound mapping point within the geometric semantic space serves as an operational definition of meaning at that point and embodies two properties that affect its meaning and location: (1) direction and (2) distance, based on direction and distance towards one bounded bipolar axis adjective or another.
(m) Multiple bipolar sounds (FIG. 5: S) that reside within the character zones (FIG.5: SA+SB+; SB+SC+; SC+SD+; SD+SA−; SA−SB−; SB−SC−; SC−SD−; SD−SA+) created by the bounded bipolar axis adjective points (FIG. 2: A+,A−; B+,B; C+,C−; D+,D−), embody a character for each sound relating to the zone in which it resides. One opposing sound of a bipolar pair always resides
(n) in a different character zone, such as one sound (S) residing in FIG. 5: character zone SC−SD− and its opposite (S) residing in FIG. 5: character zone SB+SC+
(o) Multiple bipolar sounds (FIG. 5: S) that reside within the same character zone, as in FIG. 5: zone SC−SD−, are similarly related in tone, with specific characteristics dependent on direction and distance towards one bounded bipolar axis adjective or another (FIG. 2: A+A−; B+B; C+C−; D+D−). Said sounds also embody similar meanings to adjectives (FIG. 3: A) and images (FIG. 4:I) that reside within the same character zone position, such as adjectives within FIG. 3: AD+AA−, images within FIG. 4: ID+IA− and sounds within FIG. 5: SD+SA−.
(p) Tonal zones (FIG. 6: TA+; TA−; TC+; TC−, FIG. 7: TB+; TB−; TD+; TD−, FIG. 8: TA+2, TA−2, FIG. 9: TC+2, TC−2, FIG. 10: TB+2, TB−2, FIG. 11: TD+2, TD−) each represent a unique overall tone related to the bounded bipolar axis adjective sets (FIG. 2: A+,A−; B+,B; C+,C−; D+,D−) that bound their specific geometric semantic space. Said tonal zones define a higher level of multiple verbal-visual associations that embody respective character zone adjective sets (FIG.3:A), image sets (FIG.4:I) and sound sets (FIG. 5: S) that are positioned within specific tonal zone boundaries. For example, tonal zone TA+ (FIG. 6) is primarily defined by axis adjective A+ (FIG. 6), while also embodying characteristics of framework axis D− and B+ (FIG. 6) together with all adjectives (A) in character zone AA+AB+; AD−AA+ (FIG.3), images (I) in character zone IA+IB+; ID−IA+ (FIG.4) and sounds (S) in character zone SA+SB+; SD−SA+ (FIG. 5) images (I) in character zone IA+IB+; ID−IA+ (FIG.4) and sounds (S) in character zone SA+SB+; SD−SA+ (FIG. 5).
(q) FIG. 12-17 illustrates two attitude constructs (A1 and A2) that would result from the preferred process as referenced in FIG. 1: Step 9. Two attitudes constructs (A1, A2) are shown mapped in FIGS. 12-17 to illustrate verbal-visual constructs representing two different brand personalities. Each attitude map diagram embodies all adjectives (FIG. 3:A), images (FIG. 4:I) and sounds (FIG. 5:S) that lie within the character zone and tonal zone areas enclosed by the respective attitude diagram construct boundary line. Each attitude diagram construct boundary line also occupies respective positions along bounded bipolar axis scales in each of FIGS. 12-17. The specific location of the attitude diagram boundary within the geometric semantic space determines the degree of intensity or strength of a character and tonal zone area, based on the amount of area enclosed and the direction and distance towards one bounded bipolar axis adjective or the other (FIG. 2: A+,A−; B+,B; C+,C−; D+,D−) along each semantic differential scale. The attitude mapping point within the geometric semantic space serves as an operational definition of meaning at that point and embodies two properties that affect its meaning and location: (1) direction and (2) distance, based on direction and distance towards one bounded bipolar axis adjective or another
(r) FIGS. 12-17 also illustrates the ability of the mapping structure to readily convey multi-dimensional characteristics of the geometric semantic space that are shared by the two attitudes where A1 and A2 diagram boundary areas overlap, as well as convey multi-dimensional characteristics to avoid, outside of the A1 and A2 diagram boundary lines.
(s) The number of individual attitude constructs (FIG. 12-17: A1; A2) are for simplified illustration purposes only and do not indicate a minimum or limit on the number of individual attitude constructs that can be diagrammed within the geometric semantic space.

I claim:

1. A multi-dimensional, bipolar scaled semantic space framework method that serves as a means to elicit, organize, link, define, compare, contrast, measure, guide and communicate verbal and visual stimuli associations pertaining to a research topic in the form of a quantitative attitude mapping construct comprising:
(a) enabling associations of verbal and visual stimuli from multi-dimensional modalities via a definable, repeatable and measurable bipolar scaling construct and stable mapping method within a geometric semantic space
(b) eliciting and mapping verbal-visual perceptions from consumers and others according to positions on bipolar scales that define intensity and direction
(c) identifying and mapping the attributes, essence and attitude of any concept according to positions on bipolar scales that define intensity and direction
(d) overlaying multiple maps of diverse modalities to compare, contrast and link
(e) illustrating relationships around shared values as well as differences
(f) aligning consumer and brand values around an attitudinal construct for appropriate development of products and services
(g) identifying differentiation space for brands, products and services
(h) utilizing metaphorical representations as verbal-visual content for communications
(i) generating correlations between two or more dimensions of verbal-visual data
(j) clarifying multi-dimensional, holistic insights necessary to attain desirable results
(k) creating a collective, educated and objective hypothesis for direction
(l) providing a multi-dimensional contextual brief for coherent communications
(m) generating a graphical representation within the geometric semantic space comprised of properties both denotative and connotative in character
(n) enabling a strategic, appropriate and common verbal-visual language
(o) reducing complexity, risk and errors via stable factors, scales, patterns and linkages

2. A method according to claim 1 wherein activities involving the verbal-visual framework method are conducted via computing technology

3. A method according to claim 1 wherein activities involving the verbal-visual framework method are integrated into a computer-based network
